(19) United States
(12) Patent Application Publication
(10) Pub. No.: US 2024/0408617 A1
(43) Pub. Date: Dec. 12, 2024

(54) IMAGING OIL CLEANER FOR AN LEP PRINTER

(71) Applicant: Hewlett-Packard Development Company, L.P., Spring, TX (US)

(72) Inventors: Doron SCHLUMM, Nes Ziona (IL); Mark SANDLER, Nes Ziona (IL); Dror KELLA, Nes Ziona (IL); Shahaf BARON, Nes Ziona (IL)

(73) Assignee: Hewlett-Packard Development Company, L.P., Spring, TX (US)

(21) Appl. No.: 18/702,953

(22) PCT Filed: Oct. 22, 2021
(86) PCT No.: PCT/US2021/056243

§ 371 Date: Apr. 19, 2024

(51) Int. Cl. B03C 5/02; B08B 1/16; B08B 1/20; G03G 15/10; G03G 21/00

(52) U.S. Cl. CPC B03C 5/028; B08B 1/165; B08B 1/20; G03G 15/10; G03G 21/0088

(57) ABSTRACT

In one example, a system to clean imaging oil from a cleaning station in an LEP printer includes an electrode plate, an electrode belt rotatable in a loop past the electrode plate, a channel to carry unfiltered imaging oil from the cleaning station between the electrode plate and the electrode belt, and a voltage source operatively connected to the electrodes to establish an electric field that causes waste in the imaging oil between the electrodes to attach to the belt.

### BACKGROUND

Liquid electro-photographic (LEP) printing uses a special kind of ink to form images on paper and other printable substrates. LEP ink contains tiny pigments encapsulated in a polymer resin, forming particles that are dispersed in a carrier liquid. The polymer particles are sometimes referred to as toner particles and, accordingly, LEP ink is sometimes called liquid toner. LEP ink usually also includes a charge control agent that helps control the magnitude and polarity of charge on the particles. In an LEP printing process, an electrostatic pattern of the desired printed image is formed on a photoconductor for each color of the image. Each color is developed by applying a thin layer of LEP ink to the patterned photoconductor. Charged polymer particles in the ink adhere to the electrostatic pattern on the photoconductor. The ink colors are transferred from the photoconductor to a heated intermediate transfer member, evaporating carrier liquid and melting the polymer particles, and then pressed on to the cooler substrate and “frozen” in place at a nip between the intermediate transfer member and an “impression” roller.

### DRAWINGS

FIG. 1 illustrates one example of an LEP printer with an electrophoretic belt imaging oil cleaner.

FIGS. 2 and 3 illustrate one example of an imaging oil cleaning system with an electrophoretic belt cleaner to clean imaging oil from the cleaning station in an LEP printer.

FIGS. 4 and 5 illustrate other examples of an imaging oil cleaning system with an electrophoretic belt cleaner to clean imaging oil from the cleaning station in an LEP printer.

FIG. 6 illustrates an example of an LEP printer print engine with an electrophoretic belt imaging oil cleaner.

FIGS. 7 and 8 illustrate another example of an imaging oil cleaning system with an electrophoretic belt cleaner to clean imaging oil from the cleaning station in an LEP printer.

FIG. 9 illustrates one example of a process to clean LEP imaging oil.

The same part numbers refer to the same or similar parts throughout the figures. The figures are not necessarily to scale.

### DESCRIPTION

LEP ink carrier liquid is commonly referred to as “imaging oil.” After each transfer, ink residue and other waste is removed from the photoconductor at a cleaning station with a rotating sponge. Waste is washed from the sponge with clean imaging oil. Dirty imaging oil from the cleaning station is cleaned and recycled to the imaging oil supply tank for re-use at the cleaning station and to supply clean oil to other printer systems. Currently, porous “mechanical” filters are used in HP Indigo LEP printers to the clean dirty imaging oil. A new electric cleaning system has been developed to remove waste particles from dirty imaging oil, extending the useful life of and possibly replacing the porous filters currently used in HP Indigo LEP printers.

Examples of the new system use a flexible electrode belt that rotates in a loop between a pair of plate electrodes. Voltage applied to the electrodes generates an electric field that causes waste particles in the dirty imaging oil passing between the belt electrode and each plate electrode to attach to the surface of the moving belt. Waste that accumulates on the moving belt is removed without interrupting the cleaning process, to continually refresh the cleaning surface. The inventors have shown that a uniform flow channel between the electrodes in an electric cleaner is not essential for effectively cleaning LEP imaging oil. The width of a 1 mm flow channel, for example, may vary by as much as ±20% without significantly diminished cleaning and without electrical breakdown. Therefore, precise part tolerances are not essential and a comparatively inexpensive flexible belt may be used for the cleaning surface electrode.

These and other examples shown in the figures and described below illustrate the claimed subject matter but do not limit the scope of the patent, which is defined by the Claims following this Description.

As used in this document: “and/or” means one or more of the connected things; a “computer readable medium” means any non-transitory tangible medium that can embody, contain, store, or maintain programming for use by a computer processor and may include, for example, circuits, integrated circuits, ASICs, hard drives, random access memory (RAM), and read-only memory (ROM); and “LEP ink” means a liquid that includes polymer particles in a carrier liquid suitable for electro-photographic printing. LEP ink carrier liquid is referred to herein as “imaging oil.”

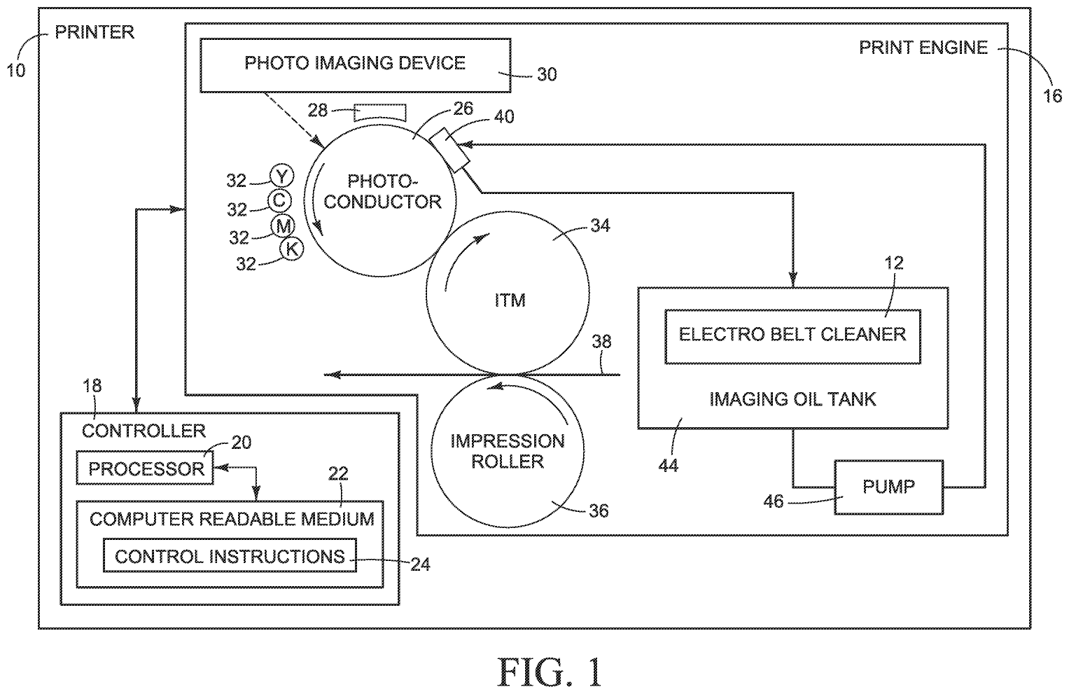

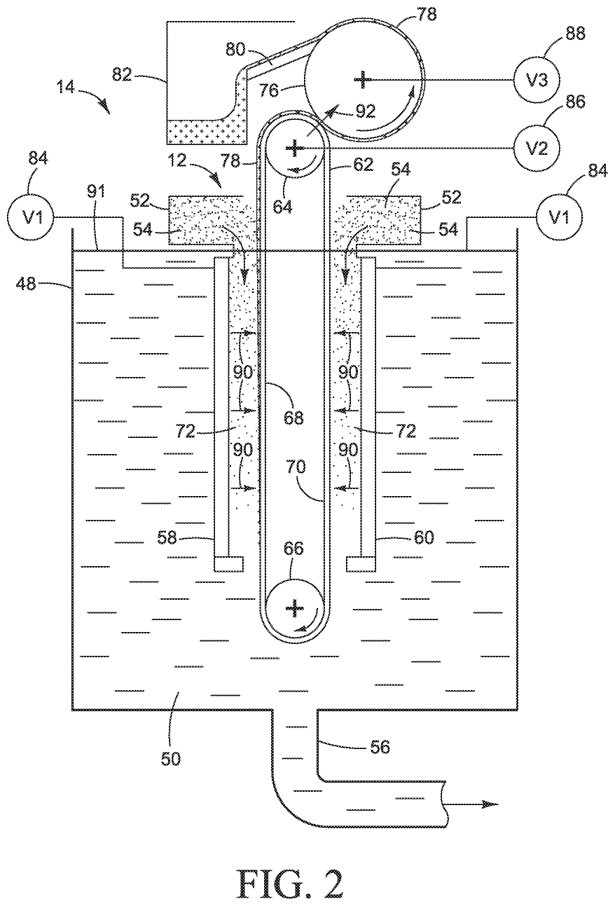

FIG. 1 illustrates one example of an LEP printer 10 with an electrophoretic belt imaging oil cleaner 12. FIG. 2 illustrates one example of an imaging oil cleaning system 14 with an electrophoretic belt cleaner 12 to clean imaging oil from a cleaning station in an LEP printer such as printer 10 shown in FIG. 1. Referring to FIG. 1, printer 10 includes a print engine 16 and a controller 18 operatively connected to print engine 16. Controller 18 includes the programming, processing and associated memory resources, and the other electronic circuitry and components to control the operative elements of printer 10. Controller 18 may include distinct control elements for individual systems and components of printer 10, including print engine 16. In particular, controller 18 in FIG. 1 includes a processor 20 and a computer readable medium 22 with control instructions 24 operatively connected to processor 20.

Print engine 16 in FIG. 1 includes a photoconductor roller 26, a scorotron, charge roller or other suitable charging device 28, a scanning laser, LED array, or other suitable photo imaging device 30, developer rollers 32, an intermediate transfer member 34, and an impression roller 36. Although four developer rollers 32 to print a color image using magenta (M), black (K), yellow (Y), and cyan (C) color separations are shown in FIG. 1, more or fewer developer rollers and/or for different colors could be used. For each color separation used to print an image, charging device 28 forms a uniform electric charge on the surface of the rotating photoconductor roller 26 and, as photoconductor roller 26 continues rotating, photo imaging device 30 illuminates selected areas on the surface of photoconductor roller 26 to alter the surface charge in a pattern of dots representing the color separation. A thin layer of LEP ink applied to photoconductor roller 26 by the corresponding developer roller 32 adheres to the pattern of dots to “develop” the color separation. Each color separation developed on photoconductor roller 22 is transferred from photoconductor 26 to a heated intermediate transfer member 34, evaporating imaging oil and melting the polymer particles, and then pressed on to a cooler printable substrate 38 and “frozen” in place at a nip between intermediate transfer member 34 and impression roller 36.

Ink residue and other waste on photoconductor roller 26 is removed with one or multiple rotating sponges at a cleaning station 40 in preparation for developing the next color separation. Waste is washed from the sponge(s) with clean imaging oil. Dirty imaging oil from cleaning station 40 is cleaned with an electrophoretic belt cleaner 12 and recycled to an imaging oil supply tank 44 for re-use at cleaning station 40, for example at the direction of controller 18 executing control instructions 24. Although not shown in FIG. 1, oil tank 42 may be supplied with new imaging oil from time to time. In the example shown in FIG. 1, electrophoretic belt cleaner 12 is integral to oil supply tank 44. Also in the example shown in FIG. 1, dirty oil drains (by gravity) to cleaner 12 and tank 44 from cleaning station 40, and clean imaging oil is pumped from tank 44 to cleaning station 40 with a pump 46. Other suitable oil transfer mechanisms between cleaning station 40, cleaner 12, and supply tank 44 are possible including, for example, pumping dirty oil to cleaner 12.

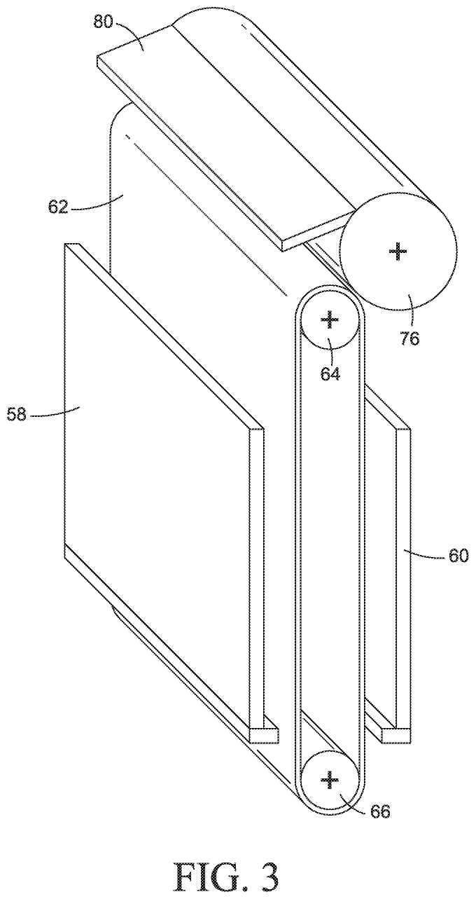

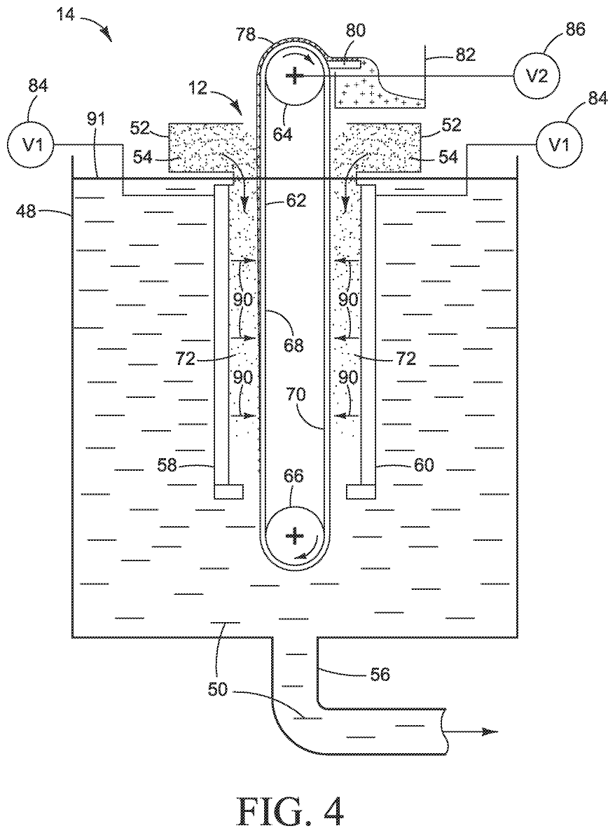

FIG. 2 is an elevation view illustrating one example of an imaging oil cleaning system 14 with an electrophoretic belt cleaner 12 such as might be implemented in an LEP printer 10 shown in FIG. 1. FIG. 3 is a perspective view showing components of cleaning system 14 from FIG. 2 in more detail. FIG. 4 illustrates another example of an imaging oil cleaning system 14 with an electrophoretic belt cleaner 12 such as might be implemented in an LEP printer 10 shown in FIG. 1.

Referring to FIGS. 2-4, each cleaning system 14 includes a tank 48, an inlet 52 through which dirty imaging oil 54 may be introduced into tank 48, and an outlet 56 through which cleaned imaging oil 50 may be removed from tank 48. Dirty imaging oil 54 is depicted by stippling in the figures. Denser stippling depicts dirtier imaging oil. In one example, tank 48 is implemented as an imaging oil supply tank 44 in an LEP printer 10 shown in FIG. 1.

Each cleaning system 14 in FIGS. 2-4 includes electrode plates 58, 60 and an electrode belt 62 rotated in a loop around rollers 64, 66 to circulate belt 62 endlessly past electrode plates 58, 60. Any suitable drive mechanism may be used to rotate belt 62 around rollers 64, 66. For example, a motor (not shown) may turn a drive roller 64 to rotate belt 62 around a tension/idler roller 66. In this example, the elongated belt loop makes a straight run 68 near electrode plate 58 and a straight run 70 near electrode plate 60. Electrode plates 58, 60 and belt runs 68, 70 form flow channels 72 that channel dirty oil 54 from inlet 52 at the top of tank 48 toward outlet 56 at the bottom of tank 48. “Near” in this context means close enough to allow an electric field that causes waste in the imaging oil in each channel 72 to attach to belt 62. The width of flow channels 72 is greatly exaggerated in the figures. Flow channels 72 are typically about 1-2 mm wide. In this example, each run 68, 70 of electrode belt 62 is parallel to the adjacent plate 58, 60 to form straight flow channels 72. Other suitable channel configurations are possible. For example, imaging oil could be channeled along a winding path between an undulating electrode and a rotating belt loop that winds along the undulating electrode, or between undulating electrodes.

In the example shown in FIGS. 2 and 3, cleaning system 14 includes a roller 76 that removes waste 78 from belt 62 and a blade 80 to scrape waste 78 from roller 76 into a waste bin 82. In the example shown in FIG. 4, a blade 80 scrapes waste 78 off belt 62 into a waste bin 82. The thickness of waste 78 on belt 62 is greatly exaggerated in the figures. Waste 78 on belt 62 is typically on the order of 5-10 μm thick.

Each cleaning system 14 in FIGS. 2-4 includes a first voltage source 84 operatively connected to electrode plates 58, 60 to apply a first voltage V1 to electrode plates 58, 60, and a second voltage source 86 operatively connected to electrode belt 62 to apply a second voltage V2 to electrode belt 62. In operation, the difference between voltage V1 and voltage V2 establishes an electric field 90 between plates 58, 60 and belt 62 that causes waste in dirty imaging oil 54 passing between electrode plates 58, 60 and electrode belt 62 to attach to electrode belt 62, as suggested by a visible and growing layer of waste 78 on belt 62 along run 68 in FIGS. 2 and 4.

In the example shown in FIGS. 2 and 3, a third voltage source 88 is operatively connected to waste removal roller 76 to apply a third voltage V3 to roller 76. The difference between voltage V2 and voltage V3 establishes an electric field 92 between belt 62 and roller 76 that causes waste 78 on belt 62 to attach to roller 76.

While the configuration and operating parameters for an electrode belt cleaning system 14 in FIGS. 2 and 4 will vary depending on the characteristics of the dirty imaging oil, testing suggests that, for a typical HP Indigo LEP printing process, dirty imaging oil 54 exposed to an electric field 90 on the order of 10³ V/mm for at least 0.33 s should be sufficient to remove enough waste to significantly extend the useful life of, and possibly replace, the porous filters currently used in HP Indigo printers. For negatively charged waste, typical of many LEP printing processes, V2 is greater than V1 (and V3 is greater than V2 in FIG. 2). In one example, for channels 72 about 2 mm wide, V2−V1≥3,000V (and V3−V2≥600V in FIG. 2). The operational flow rate of imaging oil through cleaner 12 to achieve the desired cleaning exposure time, as well as the desired level 91 of oil in tank 48, may be controlled by any suitable configuration of valves and/or pumps for gravity/drain and/or pump systems 14.

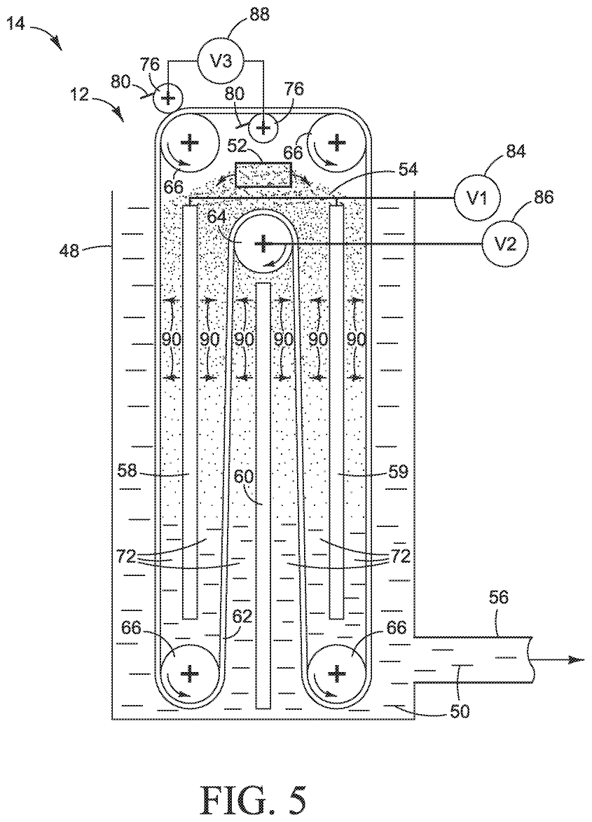

FIG. 5 illustrates another example of an imaging oil cleaning system 14 with an electrophoretic belt cleaner 12 such as might be implemented in an LEP printer 10 shown in FIG. 1. Referring to FIG. 5, cleaning system 14 includes a tank 48, an inlet 52 through which dirty imaging oil 54 may be introduced into tank 48, and an outlet 56 through which cleaned imaging oil 50 may be removed from tank 48. Tank 48 may be implemented as an imaging oil supply tank 44 in an LEP printer 10 shown in FIG. 1. Cleaning system 14 includes electrode plates 58, 60 and an electrode belt 62 rotated in a loop around rollers 64, 66 to circulate belt 62 endlessly past electrode plates 58, 60. In this example, belt 62 winds back and forth along plates 58, 60 in a serpentine path to collect waste from dirty oil 54 in flow channels 72 on both sides of belt 62.

Cleaning system 14 in FIG. 5 includes a roller 76 on each side of belt 62 to remove waste from belt 62 and a respective blade 80 that scrapes waste from each roller 76. A first voltage source 84 applies a first voltage V1 to electrode plates 58, 60 and a second voltage source 86 applies a second voltage V2 to electrode belt 62. In operation, the difference between voltage V1 and voltage V2 establishes an electric field 90 between plates 58, 60 and belt 62 that causes waste in dirty imaging oil 54 passing through flow channels 72 to attach to electrode belt 62. A third voltage source 88 applies a third voltage V3 to rollers 76. The difference between voltage V2 and voltage V3 establishes an electric field between belt 62 and rollers 76 that causes waste on each side of belt 62 to attach to a respective roller 76.

As noted above, the width of each flow channel 72 may vary by as much as ±20% without significantly diminished cleaning or electrical breakdown. As a result, the inboard runs of belt 62 in FIG. 2 are not exactly parallel to the adjacent electrodes 58 and 60, allowing belt 62 to pass through multiple electrode pairs for waste removal on both sides of the belt.

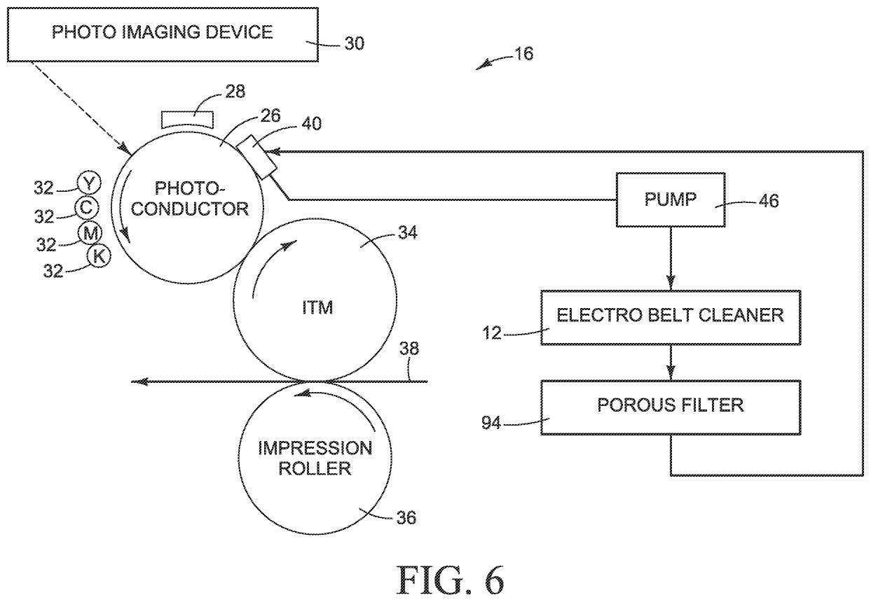

FIG. 6 illustrates an example of an LEP printer print engine 16 with an inline, tankless electrophoretic belt imaging oil cleaner 12. Referring to FIG. 6, print engine 16 includes a photoconductor roller 26, a charging device 28, a photo imaging device 30, developer rollers 32, an intermediate transfer member 34, and an impression roller 36. The printing operation of print engine 16 in FIG. 6 is described above with reference to FIG. 1. Print engine 16 in FIG. 6 also includes a pump 46 that circulates imaging oil from cleaning station 40, through cleaner 12 and a porous filter 94, and back to cleaning station 40.

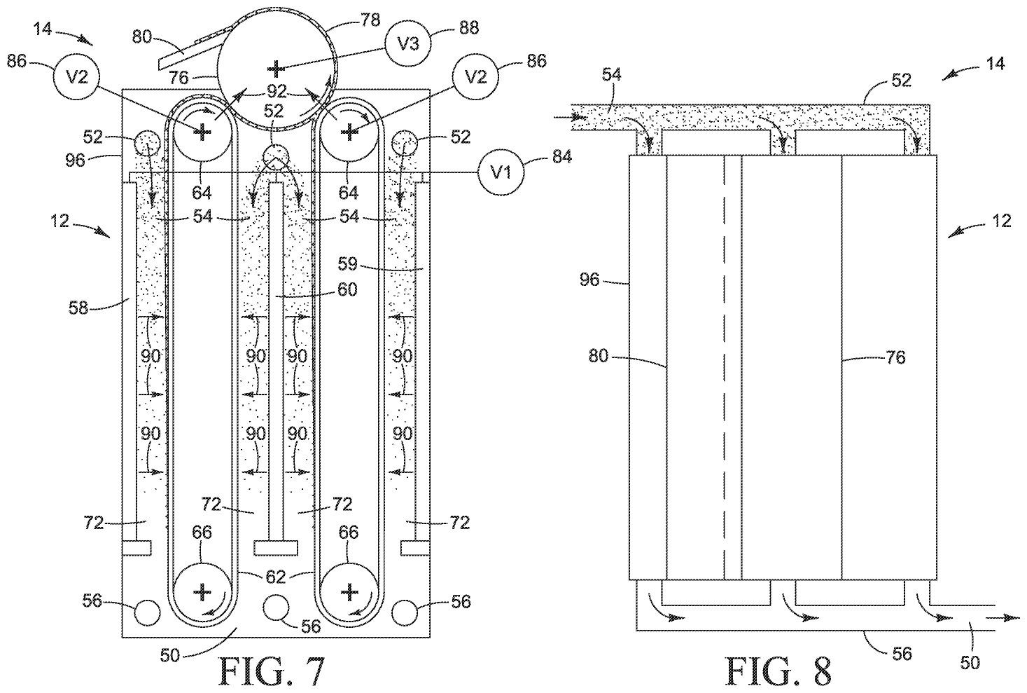

FIGS. 7 and 8 illustrate one example of an imaging oil cleaning system 14 with an inline, tankless electrophoretic belt cleaner 12 to clean imaging oil 50, 54 from the cleaning station in an LEP print engine such as print engine 16 shown in FIG. 6. FIG. 7 is an elevation view of system 14. FIG. 8 is a top down plan view of system 14 from FIG. 7. Referring to FIGS. 7 and 8, system 14 includes a housing 96 to contain imaging oil 50, 54 passing through cleaner 12, an inlet 52 through which dirty imaging oil 54 may be introduced into housing 96, an outlet 56 through which cleaned imaging oil 50 may be removed from housing 96, electrode plates 58, 59, 60, and electrode belts 62 each rotated in a loop around rollers 64, 66 past a respective pair of electrode plates 58, 59, 60. Electrode plates 58, 59, 60 and belts 62 form flow channels 72 that channel dirty oil 54 from inlet 52 at the top of tank housing 96 toward outlet 56 at the bottom of housing 96. Cleaning system 14 in FIGS. 7 and 8 also includes a single roller 76 that simultaneously removes waste 78 from both belts 62 and a blade 80 to scrape waste 78 from roller 76.

In cleaning system 14 in FIG. 7, a first voltage source 84 applies a first voltage V1 to electrode plates 58, 59, 60, a second voltage source 86 applies a second voltage V2 to electrode belts 62, and a third voltage source 88 applies a third voltage V3 to roller 76. In operation, the difference between voltage V1 and voltage V2 establishes an electric field 90 between plates 58/60, 59/60 and a respective belt 62 that causes waste in dirty imaging oil 54 passing between the electrode plates and the belts to attach to each electrode belt 62, as suggested by a visible and growing layer of waste 78 on each belt 62 in FIG. 7. The difference between voltage V2 and voltage V3 establishes an electric field 92 between each belt 62 and roller 76 that causes waste 78 on belts 62 to attach to roller 76.

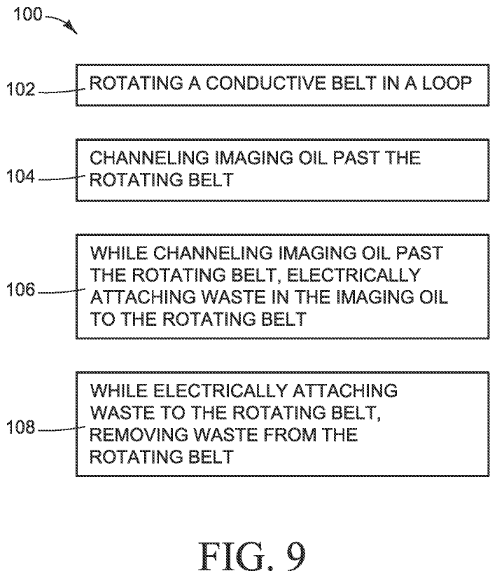

FIG. 9 illustrates one example of a process 100 to clean LEP imaging oil such as might be implemented by a controller 18 in an LEP printer 10 in FIG. 1 executing control instructions 24. Referring to FIG. 9, cleaning process 100 includes rotating a flexible conductive belt in a loop (block 102), channeling the imaging oil past the rotating belt (block 104), while channeling the imaging oil past the rotating belt, electrically attaching waste in the imaging oil to the rotating belt (block 106), and, while electrically attaching waste to the rotating belt, removing waste from the rotating belt. Process 100 may be performed, for example, using a cleaning system 14 shown in FIGS. 2, 4, 5 and 7.

“A” and “an” in the Claims means one or more. For example, “a voltage source” means one or more voltage sources and subsequent reference to “the voltage source” means the one or more voltage sources.

1. A system to clean imaging oil from a cleaning station in an LEP printer, the system comprising:
a tank;
an inlet through which dirty imaging oil from the cleaning station may be introduced into the tank;
an outlet through which cleaned imaging oil may be removed from the tank and returned to the cleaning station;
a first electrode in the tank;
a second electrode near the first electrode, the second electrode comprising a belt rotatable in a loop past the first electrode; and
a voltage source operatively connected to the first electrode and to the second electrode belt to cause charged waste in the imaging oil between the electrodes to attach to the belt.

2. The system of claim 1, wherein:
the first electrode is oriented vertically in the tank;
the second electrode belt loop is oriented vertically in the tank;
the inlet is positioned near a top of the tank to introduce imaging oil from the cleaning station into the tank between the first electrode and the second electrode belt; and
the outlet is positioned near a bottom of the tank below the electrodes.

3. The system of claim 1, wherein:
the first electrode comprises multiple first electrodes; and
the second electrode belt loop is rotatable through a serpentine path that passes multiple pairs of the first electrodes.

4. The system of claim 1, wherein:
the first electrode comprises multiple first electrodes; and
the second electrode belt loop is rotatable between two of the first electrodes.

5. The system of claim 4, wherein the second electrode comprises multiple second electrodes each comprising a belt rotatable in a loop between two of the first electrodes.

6. The system of claim 1, wherein:
the voltage source is operatively connected to the first electrode to apply a first voltage to the first electrode; and
the voltage source is operatively connected to the second electrode belt to apply a second voltage to the second electrode belt greater than the first voltage to cause negatively charged waste in the imaging oil between the electrodes to attach to the belt.

7. The system of claim 6, comprising:
a roller close to the belt above a level of imaging oil in the tank, the voltage source operatively connected to the roller to apply a third voltage to the roller greater than the second voltage to cause waste on the belt to attach to the roller; and
a blade to scrape waste off the roller.

8. A system to clean imaging oil from a cleaning station in an LEP printer, the system comprising:
an electrode plate;
an electrode belt rotatable in a loop past the electrode plate;
a channel to carry unfiltered imaging oil from the cleaning station between the electrode plate and the electrode belt; and
a voltage source operatively connected to the electrodes to establish an electric field that causes waste in the imaging oil between the electrodes to attach to the belt.

9. The system of claim 8, comprising a porous filter downstream from the electrodes in a direction the imaging oil flows through the system.

10. The system of claim 8, comprising a blade to scrape waste off the belt.

11. The system of claim 8, wherein the channel is defined at least in part by the two electrodes.

12. A process to clean imaging oil in an LEP printer, comprising:
rotating a conductive belt in a loop;
channeling imaging oil past the rotating belt; and
while channeling imaging oil past the rotating belt, electrically attaching waste in the imaging oil to the belt.

13. The process of claim 12, wherein electrically attaching waste in the imaging oil to the belt comprises establishing an electric field moving waste in the imaging oil to the belt.

14. The process of claim 12, comprising, while electrically attaching waste to the belt, removing waste from the rotating belt.

15. The process of claim 14, wherein removing waste from the rotating belt comprises electrically pulling waste of off the rotating belt on to a rotating roller and scraping waste off the rotating roller.
